(19) United States
(12) Patent Application Publication
(10) Pub. No.: US 2016/0123008 A1
(43) Pub. Date: May 5, 2016

(54) STRUCTURAL SANDWICH ELEMENT AND METHOD FOR PRODUCING SAME

(71) Applicant: Fredy ISELI, Uttwil (CH)

(72) Inventor: Fredy Iseli, Uttwil (CH)

(21) Appl. No.: 14/897,073

(22) PCT Filed: Jun. 4, 2014
(86) PCT No.: PCT/EP2014/061608

§ 371 Date: Dec. 9, 2015

(30) Foreign Application Priority Data
Jun. 13, 2013 (DE) 10 2013 106 174.5
Aug. 16, 2013 (DE) 10 2013 108 874.0

(51) Int. Cl. E04C 2/26; B32B 13/08; B32B 3/12; B32B 13/00; B32B 37/14; B32B 37/10

(52) U.S. Cl. CPC E04C 2/26; B32B 37/146; B32B 37/10; B32B 3/12; B32B 13/00; B32B 13/08; B32B 2260/02; B32B 2260/044; B32B 2307/3065; B32B 2307/712; B32B 2307/50; B32B 2607/00

(57) ABSTRACT

A structural sandwich element, especially wall element, comprising at least one cellulose honeycomb core having a plurality of juxtaposed channels, the honeycomb core being accommodated between a first and a second cover layer. The first and/or the second cover layer is/are a concrete cover layer, especially from high-performance concrete, or a gypsum cover layer.

### BACKGROUND OF THE INVENTION

The invention relates to a structural sandwich element, more particularly for use as a bearing element in buildings, for example as a house or room wall, or a as a floor or ceiling element or bridge element in accordance with the introductory section of claim 1, wherein the structural sandwich element comprises at least one cellulose honeycomb core, more particularly a paper or cardboard honeycomb core which is accommodated between at least two cover layers.

Cellulose honeycomb cores are described, for example, in DE 10 305 747 A1, DE 19 654 672 A1 as well as DE 19 820 493 A1.

Such structural sandwich elements have proven their worth, particularly when the cellulose honeycomb core is coated with an impregnation coating to increase resistance to fire and water as well as to increase mechanical stability. From WO 2012/045653 it is known to provide so-called honeycomb composite bearing components (cellulose honeycomb cores) with a cement coating (impregnation coating) in a vacuum, wherein the coated cellulose honeycomb core can be included as a core layer between wooden, cardboard, foamed plastic or plywood layers.

Known structural sandwich elements have proven their worth—the invention is based on proposing an alternative structural sandwich element which is characterised by increased resistance and bearing capacity. The aim of the invention also consists in setting out a method of producing such structural sandwich elements as well as a system comprising at least two juxtaposed structural sandwich elements.

With regard to the structural sandwich element, this objective is achieved by way of the features of claim 1, with regard to the method with the feature of claim 11, and with regard to the system with the features of claim 19. Advantageous further embodiments of the invention are set out in the sub-claims. The invention also covers all combinations of at least two of the features disclosed in the description, the claims and/or the figures.

In order to avoid repetition, features disclosed in relation to the device also apply in relation to the method. Equally, features disclosed in relation to the method should also apply and be claimable in relation to the device.

### SUMMARY OF THE INVENTION

The invention is based on the concept of using as a first and/or second layer a concrete cover layer, which particularly preferably is made of a flowable high-performance concrete, for example, the high-performance concrete marketed by the company Dyckerhoff AG under the brand “Flowstone”. The cover layers thereby close off the channels of the cellulose honeycomb core. By using concrete as the first and/or second cover layer the bearing capacity of the structural sandwich element is considerably increased and, in addition, the fire resistance is essentially improved. The structural sandwich element designed in accordance with the concept of the invention can, in particular, be used in the construction sector as a wall element, ceiling or floor element or as a bridge bearing element. In comparison with structural sandwich elements without a cellulose honeycomb core, the structural sandwich element in accordance with the invention is characterised by a comparatively low weight as well as sound and thermal insulation properties, more particularly if, as can be envisaged in the form of a further embodiment, the channels are filled with appropriate insulating material.

In accordance with one variant of embodiment of the structural sandwich element, the invention is based on the concept of using as a first and/or second cover layer a gypsum cover layer, more particularly in the form of a gypsum plasterboard. Here, a gypsum cover layer is essentially taken to mean a cover layer containing gypsum. Preferably the gypsum cover layer consists of at least 50% by weight gypsum, very particularly preferably of approximately 100% by weight. If necessary, other components, for example lime, or as will be explained below, fibres and suchlike materials may be mixed into the gypsum. The first and/or second cover layer in the form of a gypsum cover layer closes off the channels of the cellulose honeycomb core. By using gypsum as a component of the first and/or second cover layer the fire resistance is considerably increased at comparatively low weight.

It is also possible to provide a gypsum cover layer and an additional concrete cover layer.

The bearing capacity of the structural sandwich element can, more particularly, be adapted through selection of the cover layer thickness.

The structural sandwich element designed in accordance with the concept of the invention, can, in particular, by used as a non-bearing element, for example as a wall element in house building. Compared with structural sandwich elements without a cellulose honeycomb core, the structural sandwich element in accordance with the invention is characterised by a very low weight as well as good sound and thermal insulation properties, more particularly if, as is envisaged in accordance with a further embodiment, the channels are filled with appropriate insulation material.

Very particularly preferably the thickness of the at least one gypsum cover layer (if such a cover layer is provided) is between around 0.5 and 2 cm, particularly preferably between around 10 mm and 15 mm, wherein it is even more preferable if the at least one gypsum cover layer has a raw density of between 600 and 800 kg/m³, preferably between 650 and 750 kg/m³.

The extent of the thickness of the cellulose honeycomb core can be adapted to the total thickness of the structural sandwich element. The total thickness of the structural sandwich element is preferably between 70 mm and 300 mm, preferably between 40 mm and 250 mm, preferably between 50 mm and 250 mm, very particularly preferably between around 75 mm and 150 mm, preferably between around 50 mm and 150 mm, wherein the cellulose honeycomb core very particularly has a thickness of between 20 mm and 190 mm, very particularly preferably between around 30 mm and 130 mm. Preferably the density of the impregnated cellulose honeycomb core is between around 150 and 200 kg/m³.

There are various possibilities with regard to the arrangement of the first and/or second cover layer. Essential is the fact that the cellulose honeycomb core is accommodated between the cover layers, wherein it is possible and preferable that at least one of the cover layers, preferably both cover layers directly adjoin the cellulose honeycomb layer and/or form the outer layers of the structural sandwich element. However, it is also alternatively conceivable to provide a (further) layer between the cellulose honeycomb core and at least one of the cover layers, or, a further layer on the outside at least one of the two cover layers which then forms the outermost layers of the structural sandwich element.

Very particularly preferred is a design of the structural sandwich element in which this not only has one single cellulose honeycomb core (which is alternatively possible), but comprises at least two cellulose honeycomb cores aligned in parallel to each other, wherein these cellulose honeycomb cores are encompassed or accommodated between two cover layers. Also possible, of course, is an arrangement with more than two cellulose honeycomb cores, more particularly exclusively three cellulose honeycomb cores, wherein adjacent cellulose honeycomb cores are preferably adhered to each other, for example directly adhered to each other or, alternatively indirectly adhered to each other with an intermediate layer, for example a wooden board, which in thus far forms the connecting member between two adjacent cellulose honeycomb cores. Essential in all cases is the fact that the single cellulose honeycomb core or, as the case may be, several cellulose honeycomb cores arranged in parallel and adjoining each other, is/are accommodated between two cover layers, of which at least one is in the form of a concrete cover layer or a gypsum cover layer. Outside at least one of the cover layers at least one further layer may be provided, or the cover layers can form the outermost layers of the structural sandwich element.

Particularly preferred is an embodiment variation in which a cellulose honeycomb core, provided with a single concrete cover layer or gypsum cover layers is directly or indirectly fixed to a further cellulose honeycomb core, for example by direct adhesion or adhesion to an intermediate board, and this further cellulose honeycomb core, or a third, i.e. yet one further cellulose honeycomb core, is provided with a second cover layer on the side facing away from the first cover layer which is particularly preferably also in the form of a concrete cover layer or gypsum cover layer.

Preferably the cellulose honeycomb core is arranged in such a way that the channels extend perpendicularly to the longitudinal surface of the structural sandwich element, i.e. perpendicularly to the outer surfaces.

As has been mentioned, it is particularly preferred if in accordance with a variant of embodiment the first and/or the second cover layer is made of so-called high-performance concrete which is initially extremely flowable, wherein such a high-performance concrete preferably exhibits a compressive strength of 65 N/mm². Preferably the cement portion of the concrete used is between 380 kg/m³ and 450 kg/m³ or more. Very particularly preferably the high-performance concrete contains additives of microsilica through which compressive strengths of over 100 N/mm² can be achieved. It is particularly preferable if the high-performance concrete meets the requirement of Austrian standard ÖB B 4710-1. Preferably the W/B value is max. 0.31 on initial testing and max. 0.34 during conformity/identity testing. The consistency is preferably F45 or higher, particularly expediently F52. Preferably the fresh temperature is less than 27° C. in order to avoid temperature-dependent stresses.

In terms of the design of the cellulose honeycomb core there are various possibilities. Essential is the fact that it involves a honeycomb body made of cellulose, more particularly paper or cardboard. This can be produced in different ways in the known manner, for example through the gluing together of several corrugated cardboard layers. Alternatively, the cellulose honeycomb core is made of a so-called expanded honeycomb body, i.e. a honeycomb element that can be pulled out, wherein kraftliner paper, testliner paper or bogus paper is suitable. Preferably the cellulose honeycomb core is a corrugated cardboard honeycomb body which, very particularly, is produced as described in WO 2012/045653 in connection with FIG. 1.

With regard to the dimensions of the structural sandwich elements there are various possibilities. Preferably these are provided in a width of 625 mm of 1250 mm and in lengths of between around 2000 and 3000 mm. Fundamentally it is possible and preferable to use identical gypsum cover layers on both sides of the cellulose honeycomb core, wherein it is also conceivable to use a gypsum cover layer on only one side and a non-gypsum layer on the opposite side, for example a concrete, wooden or plastic layers.

In one form of embodiment with a concrete cover layer it is conceivable to use a concrete cover layer on only one side and a non-concrete layer on the other side, for example a gypsum, wooden or plastic layer. It is also conceivable to use different cover layers of different thickness on both sides in order to thereby be able to optimally adjust the strength, the sound insulation value and suchlike.

In relation to the design of the cellulose honeycomb core there are various possibilities. Essential is the fact that it involves a honeycomb body made of cellulose, more particularly paper or cardboard. This can be produced in different ways in the known manner, for example through the gluing together of several corrugated cardboard layers. Alternatively, the cellulose honeycomb core is made of a so-called expanded honeycomb body, i.e. a honeycomb element that can be pulled out, wherein kraftliner paper, testliner paper or bogus paper is suitable. Preferably the cellulose honeycomb core is a corrugated cardboard honeycomb body which, very particularly, is produced as described in WO 2012/045653 in connection with FIG. 1.

For creating at least one concrete cover layer, it has been found to be particularly advantageous if the thickness of the first and/or second concrete layer is selected from a value range between 5 mm and 40 mm, very particularly preferably between 8 mm and 30 mm. Particularly preferably the thickness is 15 mm.

As stated in the introduction, it is particularly preferable if the channels (cells) of the cellulose honeycomb core are coated, preferably completely circumferentially and axially continuously, with a preferably mineral, more particularly cement-based, impregnation layer in order to increase resistance to fire and/water and/or to increase the mechanical stability. The coating can preferably be in the form described in WO 2012/045653. It is particularly preferable if, as will be explained below, the first and/or the second concrete cover layer protrude(s) perpendicularly to the longitudinal surface of the structural sandwich element, into the channels (cells) of the cellulose honeycomb core and there adjoin(s) the impregnation coating, preferably being internally/firmly bonded thereto.

As stated in the introduction, it is fundamentally possible for a further board layer to be provided between the cellulose honeycomb core and at least one of the cover layers, wherein it is particularly preferable if the cellulose honeycomb core and the first and/or second cover layer are immediately adjacent to each other. There are various methods of production of this embodiment in particular. A particularly simple possibility consists in gluing the first cover layer in the form of a concrete cover layer or gypsum cover layer to the cellulose honeycomb core by means of a suitable adhesive. However, alternatively and preferably an additional adhesive is dispensed with and/or the first and or cover layer bond closely with the cellulose honeycomb core as they harden. For this it is preferable if during hardening the cellulose honeycomb core protrudes into the still moist, preferably highly flowable concrete, more particularly flowable high-performance concrete, or alternatively into the at least still moist, preferably still flowable gypsum material (consisting of gypsum or at least gypsum-containing material), so that the connection between the cellulose honeycomb core and the first and/or second cover layer is not only formed marginally, i.e. on the surface sides of the cellulose honeycomb core, but also within the channels, preferably extending perpendicularly to the longitudinal surface of the cellulose honeycomb core/structural sandwich element. It is preferable if the cellulose honeycomb core protrudes at least 0.5 cm into the concrete or the gypsum material of the first and/or second cover layer (perpendicular to the longitudinal surface of the structural sandwich element, preferably over a section from value range of between 0.5 mm and ⅔ of the cover layer thickness.

Particularly if the cellulose honeycomb core is provided with a mineral, preferably cement-based impregnation layer within the channels particularly good adhesion of the first and/or second concrete cover layer or gypsum cover layer can be achieved, wherein it is especially preferred if the impregnation coating is still moist or at least not fully hardened.

There are various possibilities with regard to the production of such a close bond in which the concrete, more particularly the high-performance concrete of the first and/or second cover layer protrudes into the channels of the cellulose honeycomb core. Particularly preferred is an embodiment variant of the production process in which the concrete is initially poured into formwork, more particularly onto a formwork table, and the cellulose honeycomb core is placed on the concrete, i.e. the concrete mass, and then inserted a little way into the concrete mass, wherein it should be avoided that the cellulose honeycomb core is pressed completely through the concrete layer, which is, however, also possible. The insertion of the cellulose honeycomb core into the concrete mass preferably takes place through it being vibrated in, wherein the cellulose honeycomb core and/or the formwork table, is made to vibrate by suitable vibration means, preferably an eccentric element. In principle the vibration can also be produced by sound waves or similar methods. In addition or alternatively to vibrating-in it is possible to mechanically produce a relative displacement movement of the formwork, more particularly the formwork table and the cellulose honeycomb core with regard to each other, preferably in that the cellulose honeycomb core is pressed perpendicularly to its longitudinal surface into the, preferably still flowable, concrete. A further alternative consists in positioning the cellulose honeycomb core relative to the formwork before or during the pouring in of the concrete into the formwork so that it partly protrudes into the formwork with the filling level of the concrete being sufficient to fill the channels with concrete in sections from below.

With regard to the time of bringing into contact, more particularly the insertion of the cellulose honeycomb core into the at least still moist concrete in order to produce a concrete cover layers there are various possibilities. Thus it is conceivable to bring the cellulose honeycomb core into contact with the concrete before or after hardening/setting of the impregnation layer.

In the preferred case of both layers, i.e. the first and the second cover layer, being made of concrete, it is preferable if initially one of the cover layers is made by one of the above-described production possibilities and that, more particularly after the at least partial drying and/or setting of the thus produced concrete cover layer, a parallel further concrete layer is produced, preferably also again in accordance with one of the above-described production measures, particularly after turning the cover layer-cellulose honeycomb core combination about 180° on the side of the cellulose honeycomb core opposite the first cover layer.

With regard to the close bonding between the preferably mineral, very particularly preferably cement-based impregnation layer and at least one gypsum cover layer, in which during production of the first and/or second cover layer the gypsum protrudes into the channels of the cellulose honeycomb core there are many possibilities. Particularly preferred is a variation of embodiment of the production method in which flowable gypsum material is initially provided and the cellulose honeycomb core is immersed in the gypsum material. Preferably the gypsum material is applied to a conveyor belt on which cellulose honeycomb cores arranged in a row are then consecutively dipped into the gypsum material.

It is particularly preferable if the gypsum material is applied to an outer layer of the relevant cover layer which, more particularly, is, in the manner of known gypsum plasterboards, made of paper or cardboard and forms the outer boundary of the cover layer.

Very particularly preferably this outer layer is placed on a conveyor belt, more particularly from a roll, and the gypsum material on the outer layer smoothed, more particularly scraped. Basically it is possible to simply place the cellulose honeycomb core on the gypsum material or allow it to sink through gravity. It is preferable if the cellulose honeycomb core is inserted into the gypsum material by a defined amount in such a way that it is prevented that the cellulose honeycomb core passes fully through the gypsum material, which however is alternatively possible, particularly if the aforesaid outer layer is provided as this limits the downward movement of the cellulose honeycomb core and prevents the cellulose honeycomb core projecting to the outer side of the relevant cover layer. The introduction of the cellulose honeycomb core into the gypsum material mass preferably takes place through vibrating it in, wherein preferably the cellulose honeycomb core and/or a suitable conveying device is made to vibrate by means of a suitable vibration element, preferably an eccentric element. In principle the vibration can also be achieved through sound waves or similar measures. In addition or alternatively to vibrating in, it is also possible to mechanically bring about a relative displacement of the carrier arrangement for the gypsum material and the cellulose honeycomb core, preferably in that the cellulose honeycomb core is pressed into the preferably still flowable gypsum material perpendicularly to its longitudinal surface. A further alternative consists in, before or during coating with gypsum material, positioning the cellulose honeycomb core in formwork and/or on a conveyor belt, so that through adding the gypsum material the cellulose honeycomb core protrudes into this material, wherein the filling level should be calculated so that channels of the cellulose honeycomb core are filled step-wise with gypsum material from below.

With regard to the time of bringing into contact, more particularly the insertion of the cellulose honeycomb core into the at least still moist gypsum material in order to produce a cover layer, there are various possibilities. Thus, it is conceivable to bring the cellulose honeycomb core into contact with the gypsum material before or after hardening/setting of the impregnation layer.

For the preferred case that both, i.e. the first and the second cover layer, are made of gypsum material, it is preferable if initially one of the decoration layers is preferably produced in accordance with one of the above-described methods, and, particularly after drying and/or setting of the thus-produced gypsum cover layer, a parallel, further gypsum layer is produced, preferably again in accordance with one of the previously described methods and more particularly after turning the cover layer-cellulose honeycomb core combination about 180°, on the side of the cellulose honeycomb core opposite the first cover layer.

As has been stated above, it is particularly preferable if the first and/or the second cover layer, more particularly the first and/or concrete or gypsum cove layer protrudes into the channels of the cellulose honeycomb core. Fundamentally it is possible that the first and/or second cover layer ends directly with the outer side of the cellulose honeycomb core, i.e. does not or only minimally protrudes outwards. Preferable, however, is a variant in which the first and/or second cover layer outwardly protrudes beyond the cellulose honeycomb core in the longitudinal direction of the channels, more particularly be several millimetres.

It is particularly preferable if, in order to optimise the thermal and or sound insulation properties of the structural sandwich element, the channels are filled with appropriate insulating material. In order to increase the sound insulation value, quartz sand is particularly suitable for filling the cells (channels). The thermal insulation value can be increased through the introduction of, more particularly, pyrogenic silicilic acid, especially in particle form. Additionally or alternatively it is conceivable to provide foamed plastic particles and/or polystyrene particles and or cellular concrete and/or recycling parties and/or mineral foam particles in the channels in order to increase the insulating effect.

In order to further increase the stability and/or bearing capacity of the structural sandwich element, it is possible to provide reinforcing material, more particularly in the form of fibres, for example glass fibres, and/or meshes, more particularly plastic or metal meshes, in the first and/or second cover layer designed as concrete cover layer.

It is particularly preferable if the structural sandwich element, particularly in the area of at least one narrow side, is provided with a connection geometry which preferably allows two adjacently arranged structural sandwich elements to be arranged in an overlapping manner in their connection direction. This can be realised in the form of a groove-spring geometry, wherein, for example, on its narrow side the structural sandwich element is provided with a groove and one of the opposite narrow sides with a spring for insertion into the groove of an adjacent structural sandwich element. Alternatively it is conceivable to provide a spring geometry on both opposite sides and to use a groove connection piece. Very particularly preferably a groove can be provided on at least one narrow side and, for example, two adjacent structural sandwich elements can be connected by way of an additional spring.

It is particularly expedient if the connection geometry, more particularly a groove for receiving a spring or a spring for insertion into a groove, is made of concrete, wherein it is particularly preferred if the connection geometry is produced in one piece with the first and/or second cover layer.

The invention also relates to a system comprising at least two adjacently arranged structural sandwich elements which are firmly connected to each other. It is conceivable and preferable if the structural sandwich elements overlap in the direction of their longitudinal surface, which can, for example, be realised through an appropriate lateral connection geometry on the narrow side, for example in the form of a groove-spring connection, wherein here, as has already been stated, there are various possibilities.

Thus, it is conceivable only to provide the structural sandwich elements with grooves and to produce the connection with a separate spring. Alternatively it is conceivable only to provide the structural sandwich elements with springs and to produce the connection via a groove connection element. It is also conceivable, more particularly on the opposite narrow sides of a structural sandwich element to provide a groove and spring so that the structural sandwich elements can be pushed into each other in an overlapping manner without adapter pieces. It is particularly preferable if, irrespective of the specific design of the connection geometry, any hollow spaces resulting through the joining of two structural sandwich elements are filled with a suitable material, more particularly gypsum material or concrete material, more particularly strongly flowable concrete.

In the event of the realisation of at least one gypsum layer it is very particularly preferable if a point of contact between two adjacent boards is externally overlapped by a further overlapping board, more particularly in the form of a gypsum cover layer, which even more preferably is fastened, for example by adhesion or screwing or suchlike, to two adjacent gypsum plasterboards.

Very particularly preferred is an embodiment of the system in which two structural sandwich elements are fixed in a spaced manner/next to each other via a casting compound, wherein the casting compound or the filling material is preferably concrete. In thus far the invention also relates to a method of producing such a system which should be able to be claimed separately. In accordance with this method two structural sandwich elements are initially arranged with a space between each other and the space, which is preferably initially provided with reinforcing material, is filled with a filling material, i.e. a casting compound, more particularly concrete, in order to connect the structural sandwich elements to each other in this manner. Preferably, in order to collect the casting compound, i.e. the filling material, the space is provided with formwork on the outside. In this way wall systems or ceiling systems can be created, wherein in the case of ceiling systems the spaced structural sandwich elements can preferably initially be placed on auxiliary supports which can be removed again after hardening of the casting compound, i.e. the filling material, more particularly the concrete.

### BRIEF DESCRIPTION OF THE DRAWINGS

Further advantages, feature and details of the invention are set out in the following description of preferred examples of embodiment as well with the aid of the drawings.

In these:

FIGS. 1a to 1c show various stages in the production of a structural sandwich element

FIG. 2 shows an alternative production stage

FIG. 3 shows a structural sandwich element designed in accordance with the concept of the invention

FIG. 4 shows an arrangement for implementing a method of producing structural sandwich elements designed in accordance with the concept of the invention,

FIG. 5 shows an example system comprising several structural sandwich elements arranged adjacent to each other, and

FIG. 6 shows an exploded view of a structural sandwich element with a total of three cellulose honeycomb cores accommodated between two cover layers,

FIG. 7 shows a ceiling construction with structural sandwich elements as shown in FIG. 6,

FIG. 8 shows an exploded view of an alternative structural sandwich element with a total of exclusively two cellulose honeycomb cores which are accommodated between two cover layers and

FIG. 9 shows a wall combination produced with structural sandwich elements shown in FIG. 8.

### DETAILED DESCRIPTION

In the Figures the same elements and elements with the same function are shown with the same reference numbers.

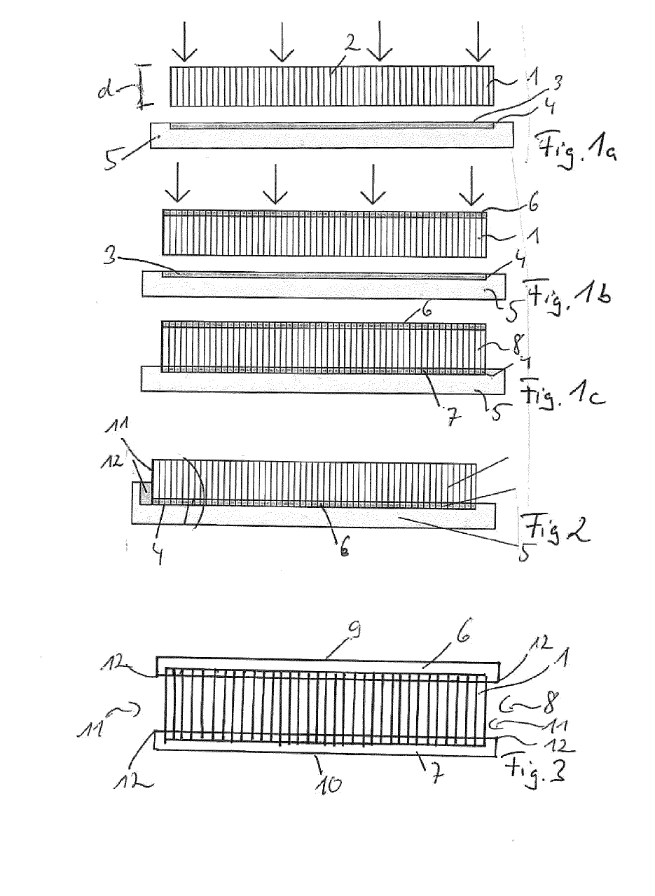

In FIG. 1a one production stage for producing a structural sandwich element is shown. A board-like cellulose honeycomb core 1 can be seen which comprises a plurality of cells, i.e. channels 2 which extend perpendicularly to the longitudinal surface of the cellulose honeycomb core 1, which in the shown example of embodiment has a thickness d (distance between the longitudinal surfaces) of 50 mm. Fully circumferentially and axially in the direction of the thickness d the channels 2 are coated with an impregnation coating, in this case based on cement, for example. The arrows in FIG. 1a indicate a direction of application in which in the cellulose honeycomb core 1 concrete 3, which is still flowable, preferably highly flowable, is applied in formwork 4. In the shown example of embodiment the formwork 4 is formed by a formwork table 5. After the placing (not shown) of the cellulose honeycomb core 1 onto the concrete 3, the cellulose honeycomb core 1 is immersed slightly into to the concrete 3, so that the channels 2 are filled with concrete 3 stage by stage. In the shown example of embodiment this procedure is carried out by causing the cellulose honeycomb core to vibrate by means of a shaking device applied from above and/or though oscillating the formwork table 5. Preferably the cellulose honeycomb core 1 is not immersed as far as the base of the formwork 4, but to a point at a distance from this base in order to ensure a closed concrete layer on the outer side. It is of course also conceivable to immerse the cellulose honeycomb core 1 to the base of the formwork 1 wherein in this case the cellulose honeycomb core 1 protrudes to the outer side of the resulting cover layer.

The cellulose honeycomb core 1 only remains positioned in the concrete 3 in the formwork 4 until the concrete 3 has dried and hardened to the extent that the combination of the cellulose honeycomb core 1 and the resulting first cover layer 6, in the form of a concrete cover layer, exhibits such strength that it can be turned about 180° into the position shown in FIG. 1b. In FIG. 1b the cellulose honeycomb core 1 with the first cover layer 6 of concrete applied thereon can be seen. This combination is then again placed, in the direction of the arrow in FIG. 1b, into formwork 4 on a formwork table 5, more particularly onto the concrete 3 present therein, and again, preferably through vibration, immerse a distance into the concrete 3 in order to thus produce the second cover layer 7, in the form of a concrete cover layer, which runs parallel to the first cover layer 6.

In the shown example of embodiment, the structural sandwich element 8 resulting from the method comprises the cellulose honeycomb core 1, which is preferably around 100 mm-200 mm thick, and the two cover layers 6, 7, which in the shown example of embodiment have a preferred thickness of between 10 mm and 25 mm. Once the second cover layer 7 has hardened sufficiently, the resulting structural sandwich element can be removed from the formwork 4 of the formwork table 5.

If required, the concrete 3 can be strengthened with reinforcement material, more particularly fibres and/or meshes. If required, the channels can be filled with suitable insulating material.

In FIG. 1c, for reasons relating to the drawing, it looks as if the cellulose honeycomb core 1 extends up to the outer siders of the cover layers 6, 7, which is possible in principle. However it is preferable if the result is a structural sandwich element 8 shown as an example in FIG. 3, wherein the cellulose honeycomb core 1 ends within the concrete cover layers 6, 7, i.e. at a distance from the outer surface 9, 10 of the cover layers 6, 7, in order to thereby obtain a smooth outer surface on the cover layers 6, 7.

In FIG. 3 it can be seen that the narrow sides 11 of the structural sandwich element are designed as grooves, i.e. a groove-shaped connection geometry 12 is created, which is produced in one piece with the cover layers 6, 7 or is formed by these.

A spring element can be inserted into the grooves of the connection geometry 12 as an adapter piece in order to thereby connect two structural sandwich elements 8 to each other on their narrow sides. Or, it is conceivable to directly insert a structural sandwich element with a spring connection profile in to the groove.

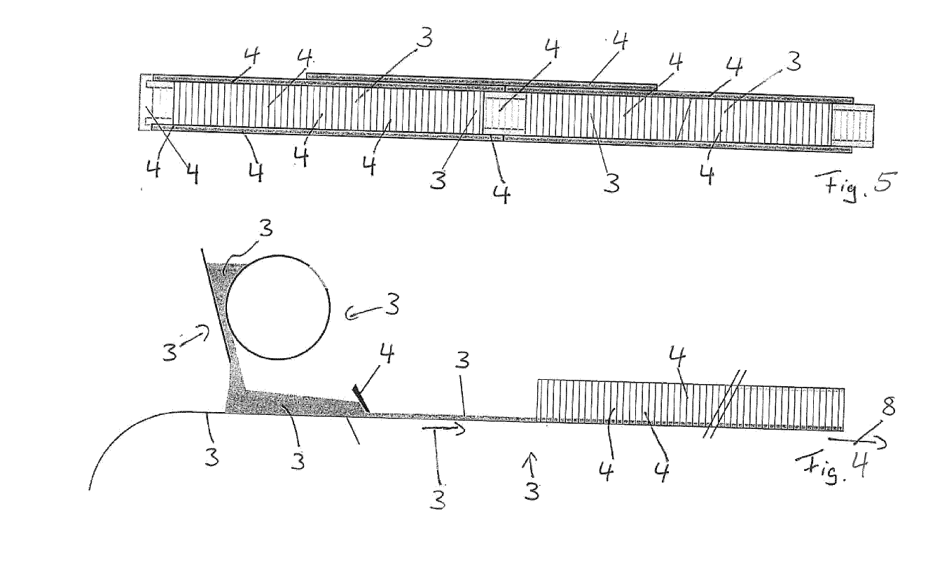

In FIG. 2 a production method stage with alternatively designed formwork 4 is shown, in which on a narrow side 11 a connection profile 12 can be cast with, or formed onto, the first cover layer 6. Such a connection profile 6 is suitable for arranging two connection profiles of two adjacent structural sandwich elements in an overlapping manner.

FIG. 4 shows a device for producing structural sandwich elements 32 shown as examples in FIG. 5. The device 31 comprises supply means 33 for the continuous supply of gypsum material 34. The supply means 33 comprise a pouring device 35, by means of which gypsum material is poured onto an outer layer 36 made of paper. The outer layer 36 is transported in one conveying direction 38 on a conveyor belt 37, which is not shown. In the conveying direction 38, after a pouring section 39 at which the gypsum material applied to the substrate 36 still exhibits an inadmissibly great thickness, thickness-limiting means 40 in the form of a scraper are provided, wherein in the conveying direction 38, the gypsum material exhibits the desired thickness after the scraper. In the conveying direction 38 after the thickness-limiting means 40 cellulose honeycomb cores 41 are placed in or on the gypsum material, wherein references is made here to the alternative possibilities in accordance with the general description. In the shown example of embodiment the cellulose honeycomb cores 41 are inserted into the gypsum material 34 in such a way that the channels 43, which are here coated with a cement-based impregnation coating 42, are filled part of the way with the gypsum material. In the shown example of embodiment the channels 42 run perpendicularly to the conveying direction 38.

Further back (not shown) in the conveying direction 38 the gypsum material is at least partially hardened, wherein, for example, the cellulose honeycomb cores with the gypsum material are applied or stacked on appropriate carriers. After the gypsum cover layer has at least partially hardened the second cover layer can be applied, more particularly through the cellulose honeycomb core provided with the first cover layer being turned about 180° and then conveyed to the same or a similar device.

FIG. 5 shows the basic structure of structural sandwich elements. These comprise a cellulose honeycomb core 31 with a plurality of channels 43 which on their inner circumference are coated with a, preferably cement-based, impregnation layer 42. On both sides of the cellulose honeycomb element 41 there is a cover layer in the form of a gypsum cover layer, wherein sandwich elements 32 comprise a first cover layer 44, and a cover layer 45 running in parallel thereto, into which the cellulose honeycomb core 41 preferably protrudes, as shown in FIG. 4 for example. Alternatively the cover layers can also be connected to the cellulose honeycomb core 41 by adhesion, for example.

It can be seen that the cover layers 44, 45 project beyond the honeycomb core 41 in the direction of its narrow side and thus form a groove-like connection geometry 46, wherein in the shown example of embodiment the structural sandwich elements 32 have a connection geometry 46 in the form of a groove on both opposite narrow sides so that two adjacent structural sandwich elements 31 can be connected via a spring element 47 which is inserted into the two groove connection geometries which are both delimited by two cover layers. In the shown example of embodiment two adjacent second cover layers of adjacent structural sandwich elements are covered in sections by an overlapping board 48, which can, for example, be designed as a gypsum plasterboard. The overlapping board 48 overlaps a point of contact between the adjacent structural sandwich elements.

In the left half of the drawing it can be seen that the connection geometry 46 can also be provided with an end profile 49 which engages in the groove-like connection geometry 46.

Alternatively designed connection geometries, as set out in the general description section can also be produced.

Very generally, i.e. not in relation to a specific example of embodiment, it is again stated that the structural sandwich elements which are covered by the concept of the invention, can have differing numbers of cellulose honeycomb cores. Thus, structural sandwich elements are realisable with exclusively one single cellulose honeycomb core which is accommodated between two cover layers, of which at least one is a concrete or gypsum cover layers. Alternatively conceivable is a design with at least or exclusively two cellulose honeycomb cores which are accommodated between two cover layers, of which one cover layer is a concrete cover layer. Also conceivable is a structural sandwich element with three, more particularly precisely three cellulose honeycomb cores or more than three cellulose honeycomb cores, wherein here too the arrangement of cellulose honeycomb cores is accommodated between two cover layers, of which at least one is a concrete cover layer or gypsum cover layer.

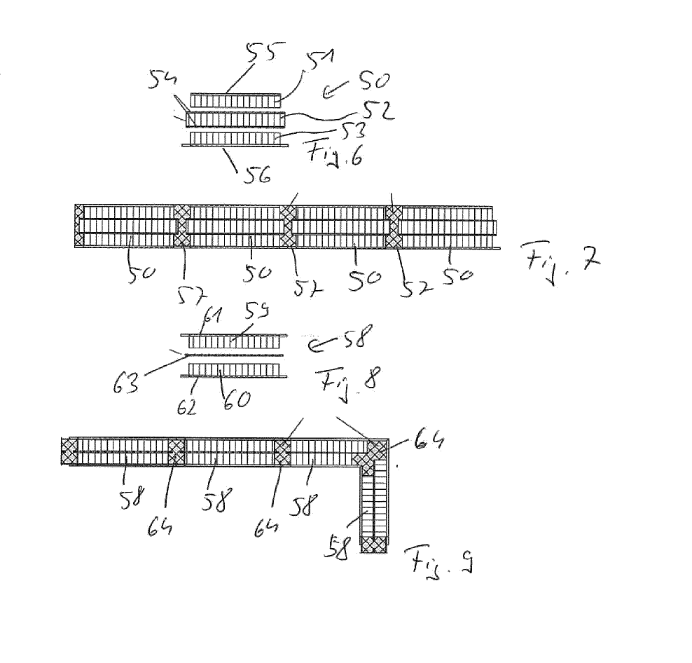

With this proviso, the examples of embodiment in accordance with FIGS. 6-9 will now be described.

FIG. 6 shows an exploded view of a structural sandwich element 50 which comprises a total of three cellulose honeycomb cores 51, 52, 53 wherein the middle cellulose honeycomb core 52 in the specific example of embodiment is adhered via an adhesive layer 54 to each of the adjoining cellulose honeycomb cores. The outer cellulose honeycomb cores 51, 53 each have one cover layer, namely a first cover layer 53 and a second cover layer 56 respectively, wherein the cover layers 55, 56 consist of concrete or gypsum. Very particularly preferably the cellulose honeycomb cores 51, 53 protrude into the associated cover layer 55 and 56 respectively, perpendicularly to their longitudinal surface—in other words, the concrete/gypsum material of the cover layers 55, 56 has penetrated into the channels of the adjacent cellulose honeycomb cores 51 and 53.

Alternatively to the single-layer cellulose honeycomb core 52, multiple-layer cellulose honeycomb cores are also conceivable, i.e. a composite of several cellulose honeycomb cores which here replaces the single-layer, middle cellulose honeycomb core 52. Instead of direct adhesion of the cellulose honeycomb cores 51, 52, 53 by way of the adhesive layers 54, a board, which is not shown, for example a wooden or plywood board, can be provided between at least two cellulose honeycomb cores 51, 52 or 52, 53.

FIG. 7 shows a ceiling structure with a structural sandwich element 50 shown as an example in FIG. 6. In FIG. 7 four adjacently arranged structural sandwich elements 50 can be seen, wherein between two adjacent structural sandwich elements support or holding areas filled with a filling material 57 are provided. In the specific example of embodiment this is preferably a concrete filling material. To produce the ceiling structure the individual structural sandwich elements 50 are initially preferably applied with auxiliary or lateral supports and spaced with regard to each other, wherein into the remaining hollow space reinforcements are preferably inserted and the filling material, more particularly flowable concrete, is then poured into the hollow space. After hardening of the filling material the auxiliary and lateral supports can be removed.

FIG. 8 shows an exploded view of an alternative structural sandwich element 58. This only comprises two cellulose honeycomb cores 59, 60 which each have a cover layer 61, 62 on the outside, wherein at least one of the cover layers is made of concrete or gypsum and preferably protrudes into the channels of the adjacent cellulose honeycomb core 59, 60.

The two cellulose honeycomb cores 59, 60 are not directly adhered to each other, which can alternatively be the case, but each have an intermediate board 63 which is designed as a single-layer or multiple-layer board, more particularly a wooden or plywood board.

In addition or as an alternative to the intermediate board 63, further cellulose honeycomb cores can also be accommodated between the cellulose honeycomb cores 59, 60.

FIG. 9 shows a wall structure produced with the structural sandwich elements in accordance with FIG. 8. It can be seen that the structural sandwich elements 58 are spaced with regard to each other and the gap is filled with filling material 64. Preferably the filling material is a flowable concrete. Particularly suitable as the filling material for filling the hollow spaces in the structures in accordance with FIGS. 7 and 9 is the high-performance concrete marketed under the name “flowstone” by the company Dyckerhoff AG.

1-21. (canceled)

22. Structural sandwich element, more particularly wall element, comprising at least one cellulose honeycomb core (1; 51, 52, 53; 59, 60) comprising a plurality of adjacently channels (2; 43) which is accommodated between a first and a second cover layer (6, 7; 44, 45; 55, 56; 61, 62), wherein the channels (2; 43) of the cellulose honeycomb core (1; 51, 52, 53; 59, 60) are fully circumferentially and axially continuously coated with a mineral, impregnation coating, which is cement-based, in order to increase the resistance to fire and/or water and/or the mechanical stability, wherein the cellulose honeycomb core (1; 51, 52, 53; 59, 60) protrudes perpendicularly to the longitudinal surface of the structural sandwich element (8; 32) into the first and/or the second cover layer (6, 7; 44, 45; 55, 56; 61, 62) and is thereby attached to the first and/or second cover layer (6, 7; 44, 45; 55, 56; 61, 62), the first and/or the second cover layer (6, 7; 44, 45; 55, 56; 61, 62) is/are produced as a concrete cover layer or as a gypsum cover layer and in that the impregnation layer is produced on the basis of micro-cement and in that the high-performance cement or the gypsum of the first and/or second cover layer (6, 7; 44, 45; 55, 56; 61, 62) protrudes slightly, at least 0.5 cm, into the channels (2; 43) of the cellulose honeycomb core (1; 51, 52, 53; 59, 60) in such a way that the high-performance concrete or the gypsum adheres to the micro-cement-based, mineral impregnation coating of the channels (2; 43).

23. Structural sandwich element according to claim 22, wherein on a side facing away from the cellulose honeycomb core the first and/or second cover layer (14, 15) has an outer layer (6; 44) in the form of a paper or cardboard layer.

24. Structural sandwich element according to claim 22, wherein the channels (2; 43) are filled with thermal and/or sound insulation material.

25. Structural sandwich element according to claim 22, wherein reinforcement material comprising fibres and/or meshes is provided in the first and/or second cover layer (6, 7; 44, 45; 55, 56; 61, 62).

26. Structural sandwich element according to claim 22, wherein on a least one narrow side (11) the structural sandwich element (8; 32; 50; 58) has a connection geometry (12; 46) for the overlapping adjacent arrangement of several structural sandwich elements (8; 32; 50; 58) in the form of a groove and/or spring geometry.

27. Structural sandwich element according to claim 26, wherein the connection geometry (12; 46) is made of concrete and is firmly connected to the first and/or second cover layer (6, 7; 44, 45; 55, 56; 61, 62) or is formed in one piece with the first and/or second cover layer (6, 7; 44, 45; 55, 56; 61, 62).

28. Structural sandwich element, more particularly wall element, comprising at least one cellulose honeycomb core (1; 51, 52, 53; 59, 60) comprising a plurality of adjacently channels (2; 43) which is accommodated between a first and a second cover layer (6, 7; 44; 55, 56; 61, 62), wherein the first and/or second cover layer (6, 7; 44; 55, 56; 61, 62) is in the form of a concrete cover layer, more particularly of high-performance concrete, or a gypsym cover layer and wherein the channels (2; 43) of the cellulose honeycomb core (1; 51, 52, 53; 59, 60) are fully circumferentially and axially continuously coated with a mineral, impregnation coating, which is cement-based, in order to increase the resistance to fire and/or water and/or the mechanical stability, wherein the cellulose honeycomb core (1; 51, 52, 53; 59, 60) protrudes perpendicularly to the longitudinal surface of the structural sandwich element (8; 32) into the first and/or the second cover layer (6, 7; 44, 45; 55, 56; 61, 62) and is thereby attached to the first and/or second cover layer (6, 7; 44, 45; 55, 56; 61, 62), and the concrete or gypsum of the first and/or second cover layer (6, 7; 44, 45; 55, 56; 61, 62) extends a distance into the channels (2; 43) of the cellulose honeycomb core (1; 51, 52, 53; 59, 60) in such a way that the concrete or gypsum adheres the cement-based, mineral impregnation coating of the channels (2; 43) and wherein between the first and the second cover layer (6, 7; 44, 45; 55, 56; 61, 62) at least two parallel cellulose honeycomb cores (1; 51, 52, 53; 59, 60) are arranged which are either directly adhered to each other or, alternatively, between which a wooden or plywood board is arranged.

29. Method of producing a structural sandwich element comprising at least one cellulose honeycomb core (1; 51, 52, 53; 59, 60) comprising a plurality of adjacently channels (2; 43) which is accommodated between a first and a second cover layer (6, 7; 44; 55, 56; 61, 62), wherein the first and/or second cover layer (6, 7; 44; 55, 56; 61, 62) is in the form of a concrete cover layer, more particularly of high-performance concrete, or a gypsym cover layer and wherein the channels (2; 43) of the cellulose honeycomb core (1; 51, 52, 53; 59, 60) are fully circumferentially and axially continuously coated with a mineral, impregnation coating, which is cement-based, in order to increase the resistance to fire and/or water and/or the mechanical stability, wherein the cellulose honeycomb core (1; 51, 52, 53; 59, 60) protrudes perpendicularly to the longitudinal surface of the structural sandwich element (8; 32) into the first and/or the second cover layer (6, 7; 44, 45; 55, 56; 61, 62) and is thereby attached to the first and/or second cover layer (6, 7; 44, 45; 55, 56; 61, 62), and the concrete or gypsum of the first and/or second cover layer (6, 7; 44, 45; 55, 56; 61, 62) extends a distance into the channels (2; 43) of the cellulose honeycomb core (1; 51, 52, 53; 59, 60) in such a way that the concrete or gypsum adheres the cement-based, mineral impregnation coating of the channels (2; 43) and wherein between the first and the second cover layer (6, 7; 44, 45; 55, 56; 61, 62) at least two parallel cellulose honeycomb cores (1; 51, 52, 53; 59, 60) are arranged which are either directly adhered to each other or, alternatively, between which a wooden or plywood board is arranged comprising the steps of:
providing a cellulose honeycomb core (1; 51, 52, 53; 59, 60), comprising a plurality of adjacently arranged channels (2; 43) which are preferably provided with an impregnation coating; and
connecting the cellulose honeycomb core (1; 51, 52, 53; 59, 60) to a first and a second cover layer (6, 7; 44, 45; 55, 56; 61, 62); wherein
the first and/or the second cover layer (6, 7; 44, 45; 55, 56; 61, 62) is/are produced as a concrete cover layer of high-performance concrete, or as a gypsum cover layer and in that the impregnation layer is produced on the basis of micro-cement and in that the cellulose honeycomb core (1; 51, 52, 53; 59, 60) is connected to the first and/or second cover layer (6, 7; 44, 45; 55, 56; 61, 62) in such a way that the cellulose honeycomb core (1; 51, 52, 53; 59, 60) is brought together with the not yet hardened high-performance concrete or gypsum material of the first and/or the second cover layer (6, 7; 44, 45; 55, 56; 61, 62), in such a way that the cellulose honeycomb core (1; 51, 52, 53; 59, 60) protrudes at least 0.5 cm into the concrete or gypsum, material and the high-performance concrete then sets or the gypsum material hardens and adheres to the micro-cement-based, mineral impregnation coating of the channels.

30. Method according to claim 29, wherein flowable concrete is provided in formwork (4), more particularly on a formwork table (5) and the cellulose honeycomb core (1; 51, 52, 53; 59, 60) is immersed in the concrete in sections, more particularly through being mechanically pressed and/or vibrated in, preferably after the cellulose honeycomb core (1; 51, 52, 53; 59, 60) has been placed on the concrete and/or the cellulose honeycomb core (1; 51, 52, 53; 59, 60) is positioned in the formwork (4) and the formwork (4) is then filled with concrete in such a way that in sections the cellulose honeycomb core (1; 51, 52, 53; 59, 60) protrudes into the concrete.

31. Method according to claim 29, wherein in order to produce the first and/or second cover layer (14, 15) flowable gypsum material (4) is provided on a conveyor belt (7; 45) on an outer layer (6; 44) of paper or cardboard arranged on a conveyor belt (7, 45), and in that the cellulose honeycomb core is immersed in sections into the gypsum material (4) through mechanical pressing in and/or through vibration and/or in that the cellulose honeycomb core (1; 51, 52, 53; 59, 60) is positioned and then has gypsum material (4) poured around it so that the cellulose honeycomb core protrudes in section into the gypsum material (4).

32. Method according to claim 29, wherein the first cover layer (6; 44) is initially connected to the cellulose honeycomb core (1; 51, 52, 53; 59, 60) and after the at least partial setting of the concrete forming the first cover layer, the second cover layer (7; 45) is connected to the cellulose honeycomb core (1; 51, 52, 53; 59, 60).

33. Method according to claim 29, wherein the cellulose honeycomb core (1; 51, 52, 53; 59, 60) is positioned in such a way that the concrete at least covers one narrow side (11) of the cellulose honeycomb core in sections and after hardening forms an end geometry (12; 46).

34. Method according to claim 29, wherein in order to ensure a constant cover layer thickness the gypsum material (4) is scraped before being introduced into the structural sandwich element.

35. Method according to claim 29, wherein the optional micro-cement-based impregnation coating, before the cellulose honeycomb core (1; 51, 52, 53; 59, 60) is combined with the not yet hardened concrete is at least still moist or alternatively already dry.
